(19) United States
(12) Patent Application Publication
(10) Pub. No.: US 2008/0073904 A1
(43) Pub. Date: Mar. 27, 2008

(54) Vacuum Lock Disconnect System and Method of Use

(75) Inventor: Srinivas M. Changalpet, Cypress, TX (US)

Correspondence Address: DUANE MORRIS LLP, 3200 SOUTHWEST FREEWAY, SUITE 3150, HOUSTON, TX, 77027, US

(73) Assignee: OCEANEERING INTERNATIONAL, INC., Houston, TX (US)

(21) Appl. No.: 11/858,223

(22) Filed: Sep. 20, 2007

Related U.S. Application Data
(60) Provisional application No. 60/847,533, filed on Sep. 27, 2006.

(51) Int. Cl. F16L 37/62

(52) U.S. Cl. 285/26

(57) ABSTRACT

This invention is directed to a system and method which uses hydrostatic pressure to lock two plates together subsea. It also allows for remotely disconnecting the two plates. A common application of this invention is for the hydraulic junction plates.

### CROSS REFERENCE TO RELATED APPLICATION

This application claims the benefit of Provisional Application Ser. No. 60/847,533, filed on Sep. 27, 2006.

### FIELD OF THE INVENTION

This invention is directed to a system and method which uses hydrostatic pressure to lock two plates together subsea. It also allows for remotely disconnecting the two plates. A common application of this invention is for the hydraulic junction plates.

### DESCRIPTION OF THE DRAWINGS

FIG. 1 is a side view of an apparatus embodiment of the invention with the plates uncoupled.

FIG. 2 is a block diagram of a method embodiment of the invention.

FIG. 3 is a block diagram of another method embodiment of the invention.

### DESCRIPTION OF THE PREFERRED EMBODIMENTS

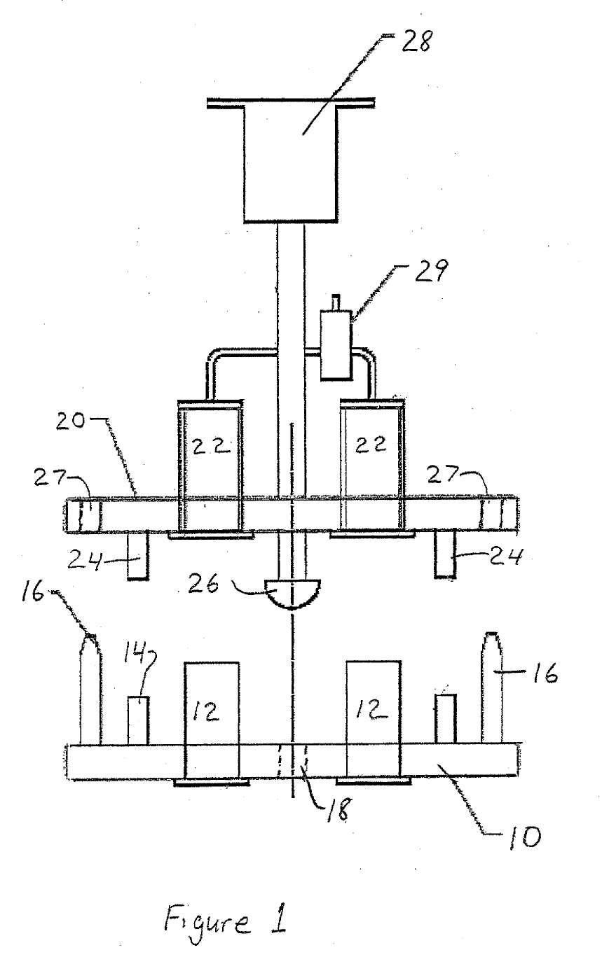

A first preferred apparatus embodiment of the invention is directed to a system for securing two structures subsea and is shown in FIG. 1. This preferred embodiment comprises a fixed structure located subsea 10. In another preferred embodiment, the fixed structure is a plate. This preferred embodiment further comprises at least one rod 12 attached to the fixed structure, and at least one first hydraulic coupler component 14 attached to the fixed structure. In a preferred embodiment, the invention further comprises a first guide member, such as at least one guide pin 16 attached to the fixed structure. In a preferred embodiment, as shown in FIG. 1, the invention comprises first and second rods 12.

The first hydraulic coupler component has a first gender, either male or female. In another preferred embodiment, the invention further comprises a first latching element, such as a latch receiver 18, attached to the fixed structure. In a preferred embodiment, the latch receiver is adapted to receive a detent mechanism, as shown in FIG. 1.

This preferred apparatus embodiment further comprises a removable structure 20, at least one rod housing 22 attached to the removable structure and adapted to snugly engage a rod, at least one second hydraulic coupler component 24 attached to the removable structure, the second hydraulic coupler adapted to engage the first hydraulic coupler component, as shown in FIG. 1 In one preferred embodiment, the rod housing is a cylinder. In a preferred embodiment, the cylindrical rod housing diameter may be configured as a function of water depth such that a required locking force is obtained.

The second hydraulic coupler component has a gender opposite to the gender of the first hydraulic coupler component. In another preferred embodiment, the removable structure is a plate, as shown in FIG. 1. In a preferred embodiment, as shown in FIG. 1, the invention comprises first and second rod housings 22 adapted to snugly receive the first and second rods, respectively.

In a preferred embodiment, the invention further comprises a second latching element, such as a latch 26, attached to the removable structure and adapted to be received by the fixed structure. In another preferred embodiment, the latch comprises a detent mechanism, as shown in FIG. 1. In a preferred embodiment, the invention may use the Junction Plate latching mechanism available from Oceaneering International Inc. of Houston, Tex., as a latch mechanism.

In another preferred apparatus embodiment, the invention comprises the features and components described above for the first preferred embodiment as well as a guide funnel; an ROV bucket 28 connected to the latch and a valve 29 installed in a line connecting each rod housing, as shown in FIG. 1. In one preferred embodiment, the valve is a pilot operated check valve. In another preferred embodiment, the valve is a check valve in parallel with a ball valve or a needle valve. The valve is open when the rod is being inserted into the rod housing. Once the rod is fully inserted into the rod housing, the valve is closed, thereby producing a vacuum locking effect between the fixed plate and the removable plate.

In a preferred embodiment, the fixed subsea plate has a closely toleranced rod attached, along with hydraulic couplers and guide pins. In one preferred embodiment, the removable plate comprises a mating guide member adapted to mate with the first guide member. In another preferred embodiment, the mating guide member is a guide funnel 27, as shown in FIG. 1. In a preferred embodiment, the removable plate has a close toleranced rod housing in the form of a cylinder along with a guide funnel 27 positioned and sized to receive each guide pin. In another preferred embodiment the fixed plate comprises first and second guide pins, and the removable plate comprises first and second guide funnels positioned and sized to receive the first and second guide pins, respectively, as shown in FIG. 1.

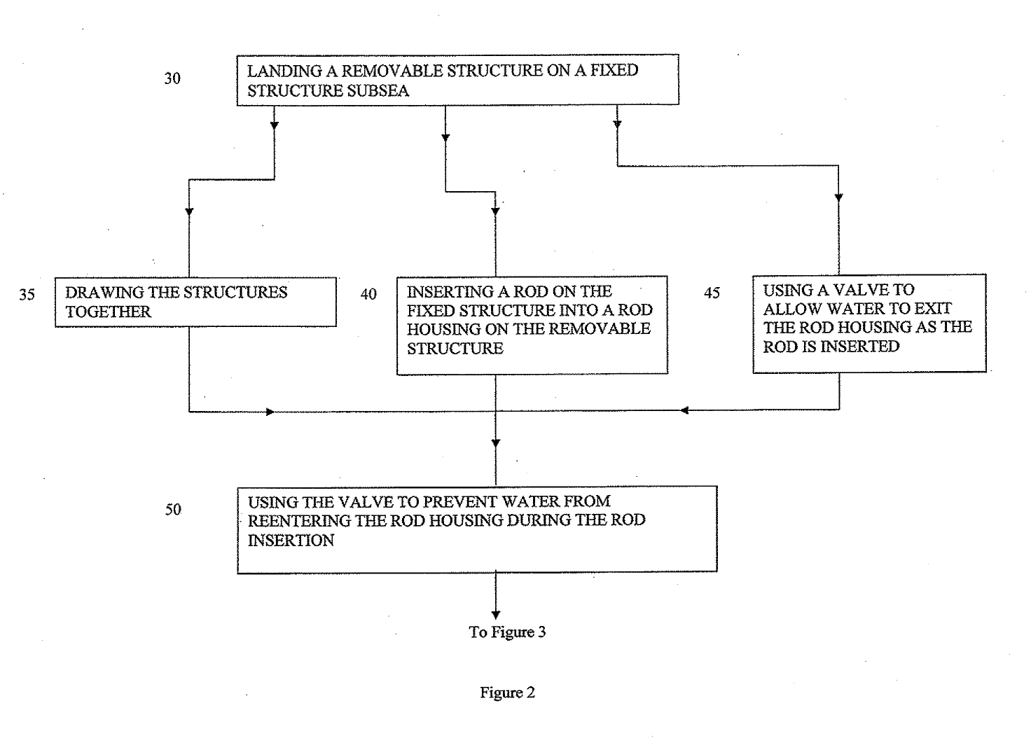

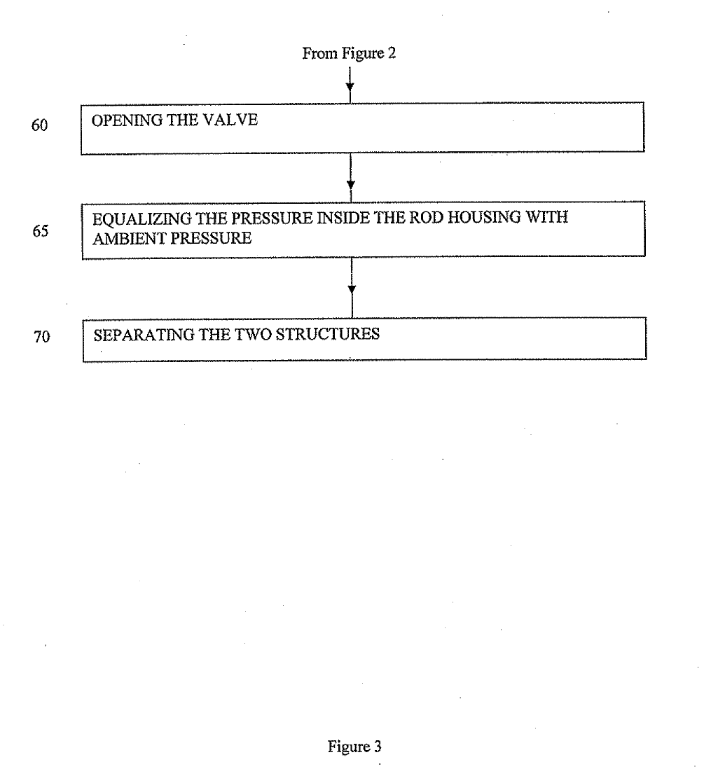

Other embodiments of the invention are directed toward methods of securing a first structure to a second structure, as shown in FIGS. 2 and 3. A first preferred method embodiment comprises the steps of landing a removable structure on a fixed structure subsea 30, drawing the structures together 35, and inserting a rod on the fixed structure into a rod housing on the removable structure 40, as shown in FIG. 2.

Additionally, as the rod is inserted, a check valve is used to allow water to exit the rod housing 45. During the inserting, a check valve is used to prevent water from reentering the rod housing 50, as shown in FIG. 2. In a preferred embodiment, steps 35, 40, 45, and 50 are performed simultaneously, as shown in FIG. 2. In a preferred embodiment, the check valve is pilot operated. In another preferred embodiment, a latching mechanism may be used to draw the structures together.

A second preferred method embodiment comprises the steps of the first preferred method embodiment as well as opening the check valve 60; equalizing the pressure inside the rod housing with ambient pressure 65; and separating the two structures 70, as shown in FIG. 3.

In a preferred embodiment, the removable plate is landed on the fixed plate and the latching mechanism is used to draw the plates together. This inserts rod/piston on the fixed plate into the rod housing on the removable plate. As the rod is inserted a pilot operated check valve allows the water to exit the rod housing. Since the check valve prevents water from reentering the rod housing as do the seals between the rod and the cylinder, the removable plate is locked to the fixed plate, by the surrounding hydrostatic pressure.

This locking force depends on the water depth and the cylinder diameter. Since the water depth is fixed the rod housing can be sized such that the required locking force is obtained. The mechanical latching device that draws the two plates together can now be unlatched.

To disconnect the plates in one embodiment, a pilot signal opens the check valve equalizing the pressure inside the rod housing with the ambient. In one preferred embodiment, the pilot signal comes from the surface. The two plates are free to separate after the pilot valve is opened.

Inherent fail safe capabilities of one or more embodiments include the operational attribute that if the hydraulic lock does not release, the plates can still be separated if sufficient external force is applied without damaging any of the components.

It will be understood that various changes in detail, parameters, and arrangements of the steps which have been described and illustrated above in order to explain the nature of this invention may be made by those skilled in the art without departing from the principle and scope of the invention.

What is claimed is:

1. A system for securing two structures subsea, comprising:
a. a fixed structure located subsea,
b. a first rod attached to the fixed structure;
c. a first hydraulic coupler attached to the fixed structure;
d. a latch receiver attached to the fixed structure;
e. a removable structure;
f. a first rod housing attached to the removable structure and adapted to snugly engage the first rod;
g. a second hydraulic coupler attached to the removable structure, the second hydraulic coupler adapted to engage the first hydraulic coupler; and
h. a latch attached to the removable structure and adapted to be received by the latch receiver.

2. The system of claim 1, further comprising:
a. a second guide pin attached to the fixed structure; and
b. a second guide funnel attached to the removable structure and sized and positioned to receive the second guide pin.

3. The system of claim 2 wherein the second guide member is a second guide pin and the second mating guide member is a guide funnel positioned and sized to fit the second guide pin.

4. The system of claim 1, wherein the structures are plates.

5. The system of claim 1, further comprising a second rod attached to the fixed structure and a second rod housing attached to the removable structure and adapted to snugly engage the second rod.

6. The system of claim 5, further comprising:
a. a line connecting the first and second rod housings; and
b. a valve installed in said line.

7. The system of claim 6, wherein the valve is a pilot operated valve.

8. The system of claim 1, wherein the latch comprises a detent mechanism and the latch receiver is adapted to receive a detent mechanism.

9. The system of claim 1, further comprising:
a. a first guide member attached to the fixed structure; and
b. a first mating guide member attached to the removable structure and adapted to mate with the first guide member.

10. The system of claim 9 wherein the first guide member is a first guide pin and the first mating guide member is a first guide funnel positioned and sized to fit the first guide pin.

11. A method of securing a first structure to a second structure subsea, comprising:
a. landing a removable structure on a fixed structure subsea;
b. using a latching mechanism to draw the structures together;
c. inserting a rod on the fixed structure into a cylinder on the removable structure;
d. as the rod is inserted, using a check valve to allow water to exit the cylinder;
e. during the inserting, using a heck valve to prevent water from reentering the cylinder; and
f. locking the removable structure to the fixed structure.

12. The method of claim 11, further comprising configuring the cylinder diameter as a function of water depth such that a required locking force is obtained.

13. The method of claim 11, further comprising:
a. determining when the fixed structure and the removable structure are mated; and
b. unlatching the fixed structure and the removable structure when the fixed structure and the removable structure are mated.

14. The method of claim 11, further comprising:
a. sending a pilot signal to open the check valve;
b. equalizing the pressure inside the cylinder with ambient pressure; and
c. separating the two structures.

15. A system for securing two structures subsea, comprising:
a. a fixed structure located subsea,
b. a first rod attached to the fixed structure;
c. a first hydraulic coupler attached to the fixed structure;
d. a latch receiver attached to the fixed structure;
e. a removable structure;
f. a first cylindrical rod housing attached to the removable structure and adapted to snugly engage the first rod;
g. a second hydraulic coupler attached to the removable structure, the second hydraulic coupler adapted to engage the first hydraulic coupler; and
h. a latching element attached to the removable structure and adapted to be received by the latch receiver.

16. The system of claim 15, further comprising a second rod attached to the fixed structure and a second cylindrical rod housing attached to the removable structure and adapted to snugly engage the second rod.

17. The system of claim 15, wherein the latch receiver comprises a detent mechanism and the latching element is adapted to receive a detent mechanism.

18. The system of claim 15, further comprising a guide member attached to the fixed structure and a mating guide member attached to the removable structure and adapted to mate with the guide member.

19. A system for securing two structures subsea, comprising:
a. a fixed structure located subsea,
b. a first rod attached to the fixed structure;
c. a first hydraulic coupler attached to the fixed structure;
d. a first latching element attached to the fixed structure;
e. a removable structure;
f. a first rod housing attached to the removable structure and adapted to snugly engage the first rod;
g. a second hydraulic coupler attached to the removable fixed structure, the second hydraulic coupler adapted to engage the first hydraulic coupler; and
h. a second latching element attached to the removable structure.

20. The system of claim 19, wherein the first latching comprises a detent mechanism and the second latching element is adapted to receive a detent mechanism.

21. The system of claim 19, further comprising a second rod attached to the fixed structure and a second rod housing attached to the removable structure and adapted to snugly engage the second rod.
